(19) United States
(12) Patent Application Publication
(10) Pub. No.: US 2009/0025092 A1
(43) Pub. Date: Jan. 22, 2009

(54) SECURE ONLINE DATA STORAGE AND RETRIEVAL SYSTEM AND METHOD

(75) Inventors: Tijuana Smith, Hinsdale, IL (US); Glendy Kam, Itasca, IL (US)

Correspondence Address: MICHAEL P. MAZZA, LLC, 686 CRESCENT BLVD., GLEN ELYN, IL, 60137, US

(73) Assignee: SECURE DATA IMAGING, LLC, Hinsdale, IL (US)

(21) Appl. No.: 11/780,943

(22) Filed: Jul. 20, 2007

(51) Int. Cl. G06F 7/04

(52) U.S. Cl. 726/30

(57) ABSTRACT

In a preferred embodiment, a secure online data storage and retrieval system and method is provided. This may include a secure database capable of storing personal data provided by users, and a website in communication with the database which may be accessible to users who enter personal information. The website can securely receive and securely transfer user personal data to or from one or more third parties, such as private and/or state and/or federal governmental entities, upon a user's request. An API source code interface or other secure method of transmission may be used for this purpose. Portions of the personal data may be authenticated by one or more third parties prior to storage in the database. In this manner, users may be permitted to quickly obtain authenticated copies of various documents or send such copies to desired recipients. This can be especially advantageous should such documents (e.g., birth certificates, passports, etc.) be lost, stolen or destroyed.

### BACKGROUND OF THE INVENTION

The present invention generally relates to a system and method for providing secure online storage, authentication, and retrieval of various documents.

Various methods are known for storing documents in an electronic database, and permitting their retrieval. Encryption and other methods are also known for securing transmission of such documents. Methods are also known for authenticating documents.

It is often necessary to access a variety of personal and business information, such as birth and marriage certificates, driving records, passports, real estate deeds, social security numbers, etc. Accessing this information requires interfacing with a variety of governmental and municipal authorities, such as Immigration within a branch the Federal government (e.g., passports), the Secretary of State (e.g., driving records, business entity information), a county clerk's office (e.g., real estate deed), etc. Each governmental authority often has its own unique hierarchy and procedures for accessing such information, which sometimes conflict. Given this daunting governmental thicket of bureaucracy, the inventors are currently unaware of a secure, online data storage and retrieval system that even attempts to interface with various state and federal authorities.

Natural disasters such as Katrina and man-made events such as terrorism have recently highlighted the need to enable access to information that may be authenticated in a secure and rapid fashion. Thousands of Katrina victims for example, who have lost their homes as well as local municipal facilities where information was stored, currently are unable to access personal information such as birth certificates, insurance-related information, social security information, etc.

Governmental agencies have been or are now expending great amounts of time and expense in imaging their documents, and providing websites that make electronic copies of those documents (PDF images, JPEG images, etc.) available to customers, typically for a fee. However, currently, a single site system for interfacing with the websites of various governmental agencies to obtain those documents, and to provide authenticated copies of them, is not available.

Accordingly, it would be advantageous to provide a system and method for storing personal and business documents online, for enabling their timely retrieval from various sources, including governmental agencies, and also for enabling their authentication and transfer in a secure and rapid fashion.

### Definition of Claim Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Authenticated personal data” means personal data that has been verified as correct by an appropriate and/or issuing governmental authority. As a non-limiting example, the U.S. Citizenship and Immigration Services department may issue an authenticated passport and/or verify that an electronic document corresponding to such passport is authentic.

“Personal data” means documents, photographs or other information, whether in physical or electronic form, corresponding to a user, which may be an individual or a business or other entity, including but not limited such items as passports, real estate deeds, social security cards, birth certificates, driver licenses, charters of incorporation, lawsuit releases, etc.

“Personal information” means a user name and password, or similar information enabling a user to logon to a website associated with a secure database of the present invention.

“Secure database” means a data store which is protected from unintended activities, such as unauthenticated misuse or malicious attacks by unauthorized personnel, or inadvertent mistakes made by authorized individuals or processes.

### SUMMARY OF THE INVENTION

The objects mentioned above, as well as other objects which will become apparent upon understanding the principles described here, are solved by the present invention, which overcomes disadvantages of prior online storage and retrieval systems and methods, while providing new advantages not previously obtainable with such systems and methods.

In a preferred embodiment, a secure online data storage and retrieval system is provided, which includes a secure database capable of storing personal data provided by users; and a website in communication with the database. The website is accessible to users who enter personal information. The website may allocate secure data space partitions for each user, and enables the user to retrieve personal data concerning the user from the partition. The website can also securely receive and securely transfer user personal data to or from one or more third parties, such as private or state and/or federal governmental entities, upon a user's request. An API source code interface or other secure method of transmission may be used for this purpose. Portions of the personal data may be authenticated by one or more third parties prior to storage in the database.

In another preferred embodiment, a process is provide for using a website interacting with a secure online data storage and retrieval system. A secure database is provided, as well as a website in communication with the database. The website may be accessible to users who enter personal information. Secure data space partitions are allocated for users. Users are enabled to utilize the website to retrieve personal data corresponding to the user from the partition. The website receives requests from users to release the personal data corresponding to the users stored in the database. Upon receipt of the requests from the users, the website verifies that the personal information relates to the corresponding user/requestor, and then the website transmits a request to one or more third parties maintaining the personal data. The website receives, via a secure transmission method, authenticated copies of the personal data from the one or more third parties and notifies corresponding users of the arrival of the authenticated copies.

In an alternative embodiment, website users may be allowed to view but not to print the authenticated copies of their personal data. Upon the user's request, the website may transmit authenticated copies of the personal data to organizations or entities (such as private entities, or state and/or federal governmental entities) designated by the user.

In yet another embodiment, an authenticated copy requested by a user may be printed on paper bearing an authenticating seal, such as a watermark: A serial number, which may be maintained by the secure database as corresponding to a specific user request, may also be printed on the authenticated copy.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a schematic view illustrating one embodiment of the present invention, in which a user may upload or download and print non-authenticated documents stored by the user in his/her space allocated by the document storage system or “secure database,” and the secure database may transmit such documents to the user;

FIG. 2 is a schematic view of an embodiment of the present invention, showing a possible workflow in which the storage system securely obtains an authenticated document at the request of a user, and the user is notified of this and permitted to view the document online;

FIG. 3 is a schematic view illustrating an embodiment of the invention, in which a user logs on to the website of the storage system, requests that a document be sent to a particular destination, the storage system processes the request, generates an authenticated copy of the document, and mails it to the user-requested destination; and

FIG. 4 is a schematic view illustrating an embodiment of the invention similar to FIG. 3, in which the storage system electronically transmits the authenticated copy of the document, via secure API, to the user-requested destination.

The components in the drawings are not necessarily to scale, emphasis instead being placed upon clearly illustrating the principles of the present invention.

### DETAILED DESCRIPTION OF THE PREFERRED EMBODIMENT

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

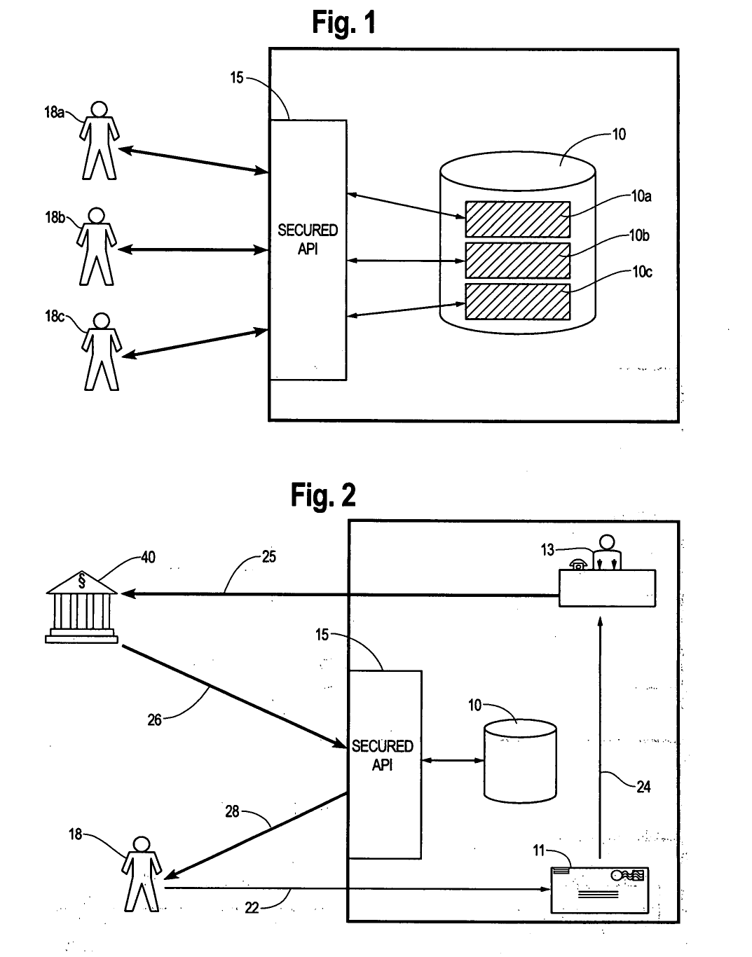

Referring first to FIG. 1, a secure database, generally designated by reference numeral 10, is shown. Information from secure database 10 may be transmitted, such as by way of a source code interface 15 (enabled by a computer system or program library) providing open API (application programming interface) technology allowing website interaction to end users 18a, 18b, 18c, etc. A suitable source code interface 15 is available from the endpoint authentication over the Internet using cryptography and takes the form of implementation of SSL via HTTPS.

End users 18a, 18b, 18c, etc., may purchase or otherwise be allocated data space or partitions 10a, 10b, 10c. etc., respectively, within secure database 10. Preferably, each end user 18, through his/her computer, PDA or other electronic device, has access only to his/her own allocated data space or partition, and may gain entry to that partition through entry of a user name and password, for example, provided to the administrator of database 10. For information that need not be authenticated, such as a user's personal calendar, phone books, or user-created documents, for example, users 18 may download and print this information from their computers and/or associated printers. Two-way transmission is enabled, as well, such that users 18 may also transmit documents or other information through source code interface 15 using open API to secure database 10.

Referring now to FIG. 2, steps involved in a preferred method of allowing secure database 10 to obtain a user's authenticated document, and to transmit that document to a user-desired destination, are shown. In the preferred method, a user 18 may initiate the process by sending to the administrator of database 10 a request in step 22, such as an authorization letter, may be made to the “mailroom” 11 of database 10 to release certain information downloadable from a website associated with database 10. Upon receipt of this request, a system administrator 13 for database 10 may verify the information provided by the end-user in step 24 (e.g., ensuring that the given username and password correspond with the requestor). In step 25, the administrator of database 10 may then submit a request, preferably electronically, to the partner organization 40 maintaining the document. The appropriate authority 40 may now transmit the requested, authenticated electronic copy of the document to the database 10 administrator in step 26 via a secured channel, through secure API 15 proprietary protocol, which may be developed with each organization on a case-by-case basis, preferably using request/receipt of a secure document. Based on the organization and its environment, an appropriate API protocol may be developed. Open API is available from the State of Illinois, Illinois Department of Central Management Service, for example. The document may then be stored in the corresponding partition of database 10 assigned to user 18. In step 28, user 18 may then be notified of the arrival of the electronic copy of the document by the administrator of database 10. The user may now be permitted to view (but preferably not to print, for security reasons) the electronic copy. Various software is available to the administrator of secure database 10 to enable viewing but to disallow printing of the electronic copy, which disables print functionality on PDF documents, or provides a watermark on a printed image stating that it is an unauthenticated document available from various document viewers (e.g., Microsoft Word from Microsoft (www.microsoft.com), Docudesk from Docudesk (www.docudesk.com)).

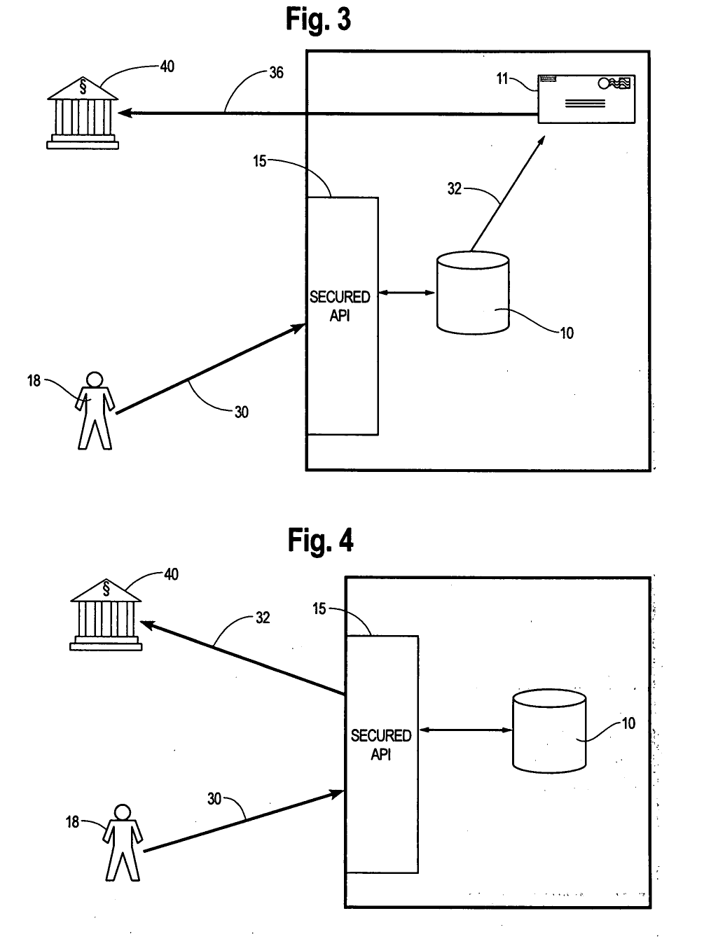

Referring now to FIG. 3, steps involved in a preferred method of retrieving and transferring an authenticated document are schematically shown. In this preferred method, a user 18 may logon to the website of the secure database 10, and make an initial request in step 30 that a particular document be forwarded to a particular destination 40. In one preferred embodiment, a user 18 may be permitted to navigate a website containing the document sought (e.g., a county recorder website), using the website associated with secure database 10, enabling the user to interface with the website containing the document sought and to download a document with an electronic certification of authenticity. This request may then be forwarded via secure API to database 10. In step 32, the administrator of database 10 may process the request and may generate (e.g., print) an authenticated copy of the requested document. In step 34, the so-generated authenticated document may then be mailed to the user-request destination 40 in step 36.

Referring now to FIG. 4, steps involved in an alternative, preferred method of retrieving and transferring an authenticated document are schematically shown. Here, in step 30 user 18 may again logon to a website associated with secure database 10, using a communication link with secure API to database 10. The administrator of the database may again process the request and may now transmit an authenticated, electronic copy of the requested document in step 32, via secure API, to the user-requested destination 40.

With regard to FIG. 3, the administrator of database 10 preferably has the ability, when printing an authenticated copy of the user-requested document, to provide the document with anti-forgery indicia, such as a special seal or watermark. Such a watermark may be produced by a special printer which produces a raised seal mark on the document, indicating that it is authentic. Alternatively, a special paper which has the “raised” watermark already incorporated within it may be used, or an anti-forgery laser hologram may perhaps also be used. For this purpose, the paper may include, for example, a serial number, such that when an authenticated document is requested by a user, the serial number will be printed on the paper containing the watermark. The serial number may be tied to a specific user request, to provide enhanced traceability.

It will now be understood that the online storage system of the present invention has the ability to provide authenticated, official documents, which may be accepted and honored by governmental and public authorities, as well as private organizations and enterprises. The online storage system functions as a channel of document communication between an end-user and/or document owner, on the one hand, and an agency which provides or requires the documents, on the other. In this manner strategic alliances may be formed with various governmental entities, including national or international entities. Additionally, the functionality of the online storage system preferably provides the intelligence to protect authenticated documents from being copied or forged by unauthorized end-users or third parties.

In a preferred embodiment of the invention, it is unnecessary for end users 18 to install any software on their computers, and files received from database 10 may be uploaded and viewed either from a Windows PC or a Mac, for example. Preferably, the website of database 10 supports Microsoft Internet Explorer 5.5 or later, or Mozilla Firebox 1.0 or later, browsers, for example.

One way to achieve a secure communication channel between secure database 10 and partner organizations would be through the use of a secure virtual tunnel (VPN). Using a VPN, sender authentication may be based on a Secure Socket Layer Based (SSL) system, a protocol developed by Netscape for transmitting private documents via the Internet, which uses a private key to encrypt data that is transferred over the SSL connection. (Both Netscape Navigator and Internet Explorer support SSL, and many websites use the protocol to obtain confidential user information, such as credit card numbers.) In one preferred embodiment, database 10 may automatically provide, for example, a secure 128-bit SSL certificate for client use. The SSL certificate may confirm the identity of the user, encrypt information sent to and from the web server, and protect information from being tampered with, with the goal being the provision of end-to-end (bit-by-bit) encryption with secure transmission.

Preferably, one or more websites associated with or in direct communication with secure database 10 enable ultra-fast Internet connectivity (thousands of times faster than a TI connection). To achieve this, dual Cisco 12000 series routers and Cisco catalyst switches may be employed, for example, and redundant fiber optic Internet connections from Tier 1 providers may be used. Redundant power supplies, diesel generators, and total UPS is preferably employed to maintain operation of the system in the event of power outages. To ensure adequate servicing of Internet volume, multiple Internet servers with 100-million hit capabilities may be employed, together with redundant RAID-5 storage (which may be backed-up off-site on a daily basis). Multilevel security, which may include biometric fingerprinting, may be provided for added security, as well as 24/7 NOC and total connection monitoring.

The facility housing secure database 10 is preferably designed to be secure. For example, it preferably has multiple power lines, employs back-up diesel generators, stores on-site back-up fuel, and the website preferably is hosted behind multiple firewalls. The use of Linux-based servers ensures that the website is immune to computer viruses and worms. Preferably, 24/7 vigilant network monitoring and constant upgrades are provided for the website, as well.

Examples of protocols which secure database 10 may adopt to provide security to its users are now discussed. Every user may be assigned a telephone number and an extension. Should a user fax a document into his/her mailbox, for example, it need not be put into the folder directly, but rather may first be placed in a temporary location. The user may then be alerted by database 10 (or a corresponding website or associated personnel) that there is a document pending to be approved/accepted. Should the user accept the fact that the document may be stored in his/her folder, it may then be allocated to the user storage area, in the corresponding partition or folder designated for that user.

Similar protocol may be adopted for emailing documents to secure database 10. Thus, each user may be assigned a unique email address, a n-digit PIN number and, if desired, other information such as an efax number. In order to avoid the receipt of spam in user mailboxes, when a user emails a document to database 10 (or its corresponding website), it may be required that the user PIN be included in the subject line. Upon receiving the email, the secure database may check if the PIN given on the user email matches the PIN stored in the secure database. If a match is found, the document may then be placed into the user's storage space within and allocated by the secure database.

To further elucidate the principles of the invention, and to demonstrate its practical uses and flexibility, several case studies will now be discussed. In the first general case study, user 18 requests a social security number report that will provide information on a person's name, aliases, and current and prior addresses; based on availability, other information, such as date of birth, age, and current and prior phone numbers may be obtained, as well. Customers that request document notarization may be requested to provide, via the website of secure database 10, a social security number and may be requested to fax to the administrator of database 10 at least two forms of identification (e.g., valid driver's license, state identification, passport, etc.). The database administrator may then conduct a social security report using an already-established Internet-based public reporting database. Once the report is returned and the user identification is verified, a PDF notarized template may then be applied to all of the users' electronic documents.

A second case study demonstrates the usefulness of the present invention, given its capabilities in provides users with the ability to upload documents to a secure database, and then to view, print or send via email or other electronic transmission those documents to any computer which is connected to the Internet. Jane Doe is about to travel to a foreign country. She made a photocopy of her passport and brought it, as well as her original passport, with her on her trip. She placed the photocopy of her passport in her checked bag, which was lost by the airline. During the process of attempting to locate her lost luggage, Jane lost her purse which contained her original passport. Jane contacted the US Consulate, but found herself in a difficult situation as she struggled to prove her citizenship and identity. Jane's problem could have been easily resolved if she had been a member of a company overseeing secure database 10. In this event, prior to her trip she could have scanned her passport and uploaded the scanned image to her account. Upon misplacing her passport, she could have simply accessed a computer, logged-on to her account, and then retrieved and printed a copy of her passport.

A third case study highlights how the present invention provides users with an easy interface to retrieve important documents from government agencies or private organizations. John lost his birth certificate, and is unable to obtain a driver's license. Instead of applying to the government for a new birth certificate, John can retrieve a copy of his birth certificate through database 10's secure API with the local responsible government agency. John can then request an authenticated copy of his birth certificate through the website associated with secure database 10 or, alternatively, request that the website send the authenticated copy of his birth certificate to the desired recipients.

It will now be understood that the present invention provides what amounts to an electronic lockbox for customers, enabling users/clients to keep and protect important documents. This can serve an important function as a disaster protection plan, providing citizens with web-based access to important records needed at crucial times. Naturally, many of these key documents are either created or held by governmental agencies. The present invention also provides a system which serves as a convenient and reliable connecting point between users/customers and governmental agencies, offering a single site to obtain and then store their key documents. Clients, through their account using the secure website, may be permitted to shop for documents which they wish to obtain. For example, a user/client can access a deed and mortgage using a county Recorder's website, and can also shop for, select and pay for documents from the Recorder's office, the Secretary of State's office, the County Clerk's office, and other governmental agencies in one place. In addition, secure database 10 and its corresponding website can interface with websites for each agency and provide an electronic certification that the document is an authentic copy. The website associated with the secure database can also ensure that the various agencies are paid fees by users, and the users may then be charged such fees by the secure database for the interfacing service of obtaining both the document and its authentication. Assuming the various agencies have imaged their documents and have websites allowing the retrieval of these documents, the agencies will not be required to make any substantial further expenditures, as the electronic protocol for obtaining the documents and their verification will be provided by secure database 10.

The above description is not intended to limit the meaning of the words used in the following claims that define the invention. For example, while preferred embodiments involving power induction principles applied to movable glass have been described above, persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

We claim:

1. A secure online data storage and retrieval system, comprising:
a secure database capable of storing personal data provided by users;
a website in communication with the database, the website being accessible to users who enter personal information;
wherein the secure database allocates secure data space partitions for each user, enabling the user to retrieve the personal data concerning the user from the partition, and wherein the website is enabled to securely receive and to securely transmit the personal data to or from one or more third parties upon a user's request, and wherein portions of the personal data may be authenticated by one or more third parties prior to storage in the database.

2. The secure online data storage and retrieval system of claim 1, wherein the one or more third parties comprise a governmental entity.

3. The secure online data storage and retrieval system of claim 1, wherein the one or more third parties comprise at least a state governmental entity and a federal governmental entity.

4. The secure online data storage and retrieval system of claim 1, wherein the secure transfer of personal data between the website and the one or more third parties utilizes an API source code interface.

5. The secure online data storage and retrieval system of claim 4, wherein the API source code interface is tailored to be appropriate for use given the specific third parties.

6. A process for using a website interacting with a secure online data storage and retrieval system, comprising the steps of:
providing a secure database, and a website in communication with the database, wherein the website is accessible to users who enter personal information;
allocating secure data space partitions for each user;
enabling the user to utilize the website to retrieve personal data concerning the user from the partition;
the website receiving requests from users to release the personal data corresponding to the users stored in the database;
upon receipt of the requests from the users, the website verifying that the personal information relates to the corresponding user/requestor, and then the website transmitting a request to one or more third parties maintaining the personal data; and
the website receiving, via a secure transmission method, authenticated copies of the personal data from the one or more third parties and notifying corresponding users of the arrival of the authenticated copies.

7. The process of claim 6, further comprising the step of the website enabling a corresponding user to view but not to print the authenticated copy of the personal data.

8. The process of claim 6, wherein the one or more third parties comprise a state governmental entity and a federal governmental entity.

9. The process of claim 6, wherein the secure transmission method uses a secure API source code interface tailored to be appropriate for use given the specific third parties.

10. The process of claim 6, further comprising the step of the website transmitting the authenticated copies of the personal data to organizations or entities designated by a corresponding user.

11. The process of claim 6, wherein the secure database enables printing of an authenticated copy of a document comprising the requested personal data corresponding to a user.

12. The process of claim 11, wherein the authenticated copy is printed on paper bearing an authenticating seal.

13. The process of claim 12, wherein the authenticating seal comprises a watermark.

14. The process of claim 11, wherein the authenticated copy includes a serial number maintained by the secure database as corresponding to a specific user request.
